(19) United States
(12) Patent Application Publication
(10) Pub. No.: US 2022/0390988 A1
(43) Pub. Date: Dec. 8, 2022

(54) DISPLAY DEVICE, DISPLAY PANEL AND DISPLAY COVER PLATE AND MANUFACTURING METHOD THEREOF

(71) Applicant: BOE TECHNOLOGY GROUP CO., LTD., Beijing (CN)

(72) Inventors: Yongxiang SHI, Beijing (CN); Paoming TSAI, Beijing (CN)

(21) Appl. No.: 17/764,579

(22) PCT Filed: May 19, 2021
(86) PCT No.: PCT/CN2021/094717

§ 371 Date: Mar. 29, 2022

(30) Foreign Application Priority Data
May 20, 2020 (CN) 202010430749.5

(51) Int. Cl. G06F 1/16; B05D 1/36; C09D 175/04; C09D 179/08

(52) U.S. Cl. CPC G06F 1/1656; G06F 1/1652; B05D 1/36; C09D 175/04; C09D 179/08; B05D 2203/30; B05D 2503/00

(57) ABSTRACT

A display cover plate includes: a substrate; a first thermoplastic material layer provided on one side of the substrate; a flexible polymer layer provided on one side of the first thermoplastic material layer away from the substrate; and a hardened layer provided on one side of the flexible polymer layer away from the first thermoplastic material layer.

### CROSS-REFERENCE TO RELATED APPLICATION

The present disclosure claims the priority of the Chinese Patent Application No. 202010430749.5 entitled “Display device, display panel, display cover plate and manufacturing method thereof” filed on May 20, 2020, and the entire contents of which are incorporated herein by reference in the entirety.

### TECHNICAL FIELD

The present disclosure relates to the field of display technology, and particularly, to a display cover plate, a method for manufacturing the display cover plate, a display panel and a display device.

### BACKGROUND

With the increasing demand for portable display devices, flexible display technology becomes one of the display technologies with great competitive advantages. An advantage of flexible display technology is foldability, which can increase the display area without increasing the volume of the display device, and is very portable.

Currently, the market share of foldable display products is increasing, and foldable display products can achieve curvablity and foldability relying on OLED display elements. Foldable products require folding radiuses reaching 3 mm or even 1 mm, and such folding conditions not only require relatively high folding resistance on lighting elements per se, but also require very high folding performance on display cover plates and the like.

It is noted that the information disclosed in the foregoing background section is only for strengthening understanding of the background of the present disclosure, and therefore may contain information that does not constitute the prior art already known to those ordinary skilled in the art.

### SUMMARY

The object of the present disclosure is to provide a display cover plate, a method for manufacturing the display cover plate, a display panel and a display device, thereby improving the hardness, the impact resistance performance and the foldability.

According to one aspect of the present disclosure, there is provided a display cover plate comprising:

a substrate;

a first thermoplastic material layer provided on one side of the substrate;

a flexible polymer layer provided on one side of the first thermoplastic material layer away from the substrate; and

a hardened layer provided on one side of the flexible polymer layer away from the first thermoplastic material layer.

In some exemplary embodiments of the present disclosure, the display cover plate further comprises:

a second thermoplastic material layer provided on one side of the substrate away from the first thermoplastic material layer.

In some exemplary embodiments of the present disclosure, material of the first thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

In some exemplary embodiments of the present disclosure, material of the second thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

In some exemplary embodiments of the present disclosure, the thickness of the first thermoplastic material layer is 30 μm to 150 μm.

In some exemplary embodiments of the present disclosure, the thickness of the second thermoplastic material layer is 30 μm to 150 μm.

In some exemplary embodiments of the present disclosure, the substrate is inorganic material.

According to another aspect of the present disclosure, there is provided a method for manufacturing a display cover plate comprising:

providing a flexible polymer layer;

forming a first thermoplastic material layer on one side of the flexible polymer layer;

forming a hardened layer on one side of the flexible polymer layer away from the first thermoplastic material layer; and

forming a substrate on one side of the first thermoplastic material layer away from the flexible polymer layer.

In some exemplary embodiments of the present disclosure, the forming the substrate on one side of the first thermoplastic material layer away from the flexible polymer layer comprises:

providing a substrate;

forming a second thermoplastic material layer on one side of the substrate; and

combining one side of the first thermoplastic material layer away from the flexible polymer layer with one side of the substrate away from the second thermoplastic material layer.

According to still another aspect of the present disclosure, there is provided a display panel comprising the foregoing display cover plate.

According to still another aspect of the present disclosure, there is provided a display device comprising the foregoing display panel.

In the display cover plate provided by the present disclosure, the flexible polymer layer is combined with the substrate through the first thermoplastic material layer, thereby avoiding the structure of OCA (Optically Clear Adhesive) attaching, and effectively improving the pencil hardness and the impact resistance performance of the display cover plate.

It should be understood that the foregoing general description and the following detailed description are merely exemplary and illustrative, and cannot limit the present disclosure.

### BRIEF DESCRIPTION OF THE DRAWINGS

The accompanying drawings here are incorporated in the specification and constitute a part of this specification, show embodiments in accordance with the present disclosure and serve to explain the principles of the present disclosure together with the specification. Obviously, the drawings in the following description are only some embodiments of the present disclosure, and for those ordinary skill in the art, other drawings can also be obtained from these drawings without creative efforts.

FIG. 1 is a schematic sectional view of a display cover plate according to some embodiments of the present disclosure;

FIG. 2 is a schematic sectional view of a display cover plate according to some other embodiments of the present disclosure;

FIG. 3 is a flow chart of a method for manufacturing a display cover plate according to some embodiments of the present disclosure;

FIG. 4 is a flow chart of a method for manufacturing a display cover plate according to some other embodiments of the present disclosure.

### DETAILED DESCRIPTION

Exemplary embodiments will now be described more fully with reference to the drawings. However, the exemplary embodiments can be embodied in multiple forms and should not be construed as limited to the examples set forth here; rather, these embodiments are provided so that present disclosure will be more thorough and complete, and will fully convey the concept of example embodiments to those skilled in the art. The described features, structures, or characteristics may be combined in one or more embodiments in any suitable manner. In the following description, many specific details are provided, thereby giving a thorough understanding of the embodiments of the present disclosure. However, those skilled in the art will realize that the technical solutions of the present disclosure may be practiced with one or more of the specific details being omitted, or other methods, devices, steps and the like may be employed. In other situations, well-known technical solutions are not shown or described in detail to avoid obscuring aspects of the present disclosure.

In addition, the drawings are merely schematic illustrations of the present disclosure and are not necessarily drawn in scale. The same reference numerals in the drawings denote the same or similar parts, and thus their repeated descriptions will be omitted. Some of the block diagrams shown in the drawings are functional entities, and do not have to correspond to physically or logically independent entities. The terms “a”, “an”, “the” and “said” are used to indicate the presence of one or more elements/components/and the like; the terms “include” and “comprise” are used to indicate open-ended inclusion and mean that additional elements/components/and the like may be present in addition to the listed elements/components/and the like; the terms “first”, “second” and the like are only used as marks, instead of limit on number of objects.

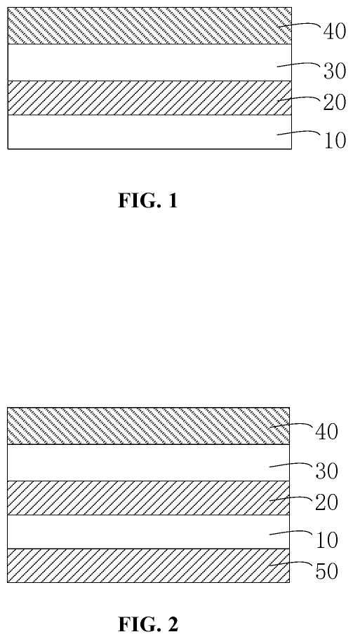

Embodiments of the present disclosure provide a display cover plate including a substrate 10, a first thermoplastic material layer 20, a flexible polymer layer 30 and a hardened layer 40 as shown in FIG. 1. The first thermoplastic material layer 20 is provided on one side of the substrate 10, the flexible polymer layer 30 is provided on one side of the first thermoplastic material layer 20 away from the substrate 10, and the hardened layer 40 is provided on one side of the flexible polymer layer 30 away from the first thermoplastic material layer 20.

The conventional flexible display cover plate is prepared by a polymer film and a hardened layer. Although such design may make the hardness of the cover plate per se reach a certain pencil hardness of 7H˜9H, when the cover plate is attached to a display module, due to presence of soft OCA therebelow, the hardness may be reduced significantly. Accordingly, the impact resistance performance is relatively poor and the performances of falling ball test and falling pen test are far away from meeting using requirement. In the display cover plate provided by the present disclosure, the flexible polymer layer 30 is combined with the substrate 10 through the first thermoplastic material layer 20, thereby avoiding the structure of OCA attaching, and effectively improving the pencil hardness and the impact resistance performance of the display cover plate.

Specifically, the substrate 10 may be an inorganic substrate, for example, an inorganic glass substrate. The conventional display cover plate may permanently deform under a high temperature and high humidity condition, thereby preventing itself from restoring to a flat state. In comparison, the display cover plate provided by the present disclosure has relatively good restorability with substrate 10 employing inorganic material, and the display cover plate may be restored to a relatively flat state even under a high temperature and high humidity condition, thereby improving the foldability, the durability and the reliability of the display cover plate.

The substrate 10 may be formed from ultra thin glass (UTG). The thickness of UTG may be 30 μm to 150 μm, for example, 30 μm, 50 μm, 70 μm, 90 μm, 100 μm, 130 μm, 150 μm, etc., which are not listed here in the present disclosure. Preferably, the thickness of UTG is 50 μm to 100 μm. A folding of R2 mm˜R5 mm may be satisfied with UTG. The width and the length of the substrate 10 are designed according to actual needs, and the thickness of the substrate 10 may be less than 30 μm or greater than 150 μm as well, which is not limited in the present disclosure. UTG is formed from inorganic material, and through employing UTG of inorganic materials as the substrate 10, the display cover plate can be restored to a relatively flat state even under a high temperature and high humidity condition.

Exemplarily, material of the first thermoplastic material layer 20 includes at least one of polyethylene (PE), polypropylene (PP), polyvinyl chloride (PVC), polystyrene (PS), polyoxymethylene (POM), polycarbonate (PC), polyamide (PA), cellulose-acrylic ester molded plastic (CAEMP), thermoplastic polyimide (TPI), thermoplastic polyurethane (TPU) and thermoplastic vulcanizate (TPV). Preferably, the first thermoplastic material layer 20 is made of thermoplastic polyimide (TPI) or thermoplastic polyurethane (TPU) material. Through the first thermoplastic material layer 20, the microcracks on the surface of the substrate 10 can be covered, thereby improving the impact resistance performance and hardness of the display cover plate.

The thickness of the first thermoplastic material layer 20 may be 30 μm to 150 μm, for example, 30 μm, 50 μm, 70 μm, 90 μm, 100 μm, 130 μm, 150 μm, etc., which are not listed here in the present disclosure. Preferably, the thickness of the first thermoplastic material layer 20 is 50 μm to 100 μm. The width and the length of the first thermoplastic material layer 20 may be designed according to actual needs. The thickness of the first thermoplastic material layer 20 may be less than 30 μm or greater than 150 μm as well, and the widths, the lengths and the thicknesses of the first thermoplastic material layer 20 and the substrate 10 may be the same or different, which is not limited in the present disclosure. Preferably, the widths and lengths of the first thermoplastic material layer 20 and the substrate 10 are the same. In other words, the orthographic projections of the first thermoplastic material layer 20 and the substrate 10 on a preset reference plane may completely coincide with each other, and the first thermoplastic material layer 20 forms a full coverage for the surface of one side of the substrate 10, thereby being able to completely cover the microcracks on the surface of the substrate 10, and further improving the impact resistance performance and the hardness of the display cover plate.

Exemplarily, the flexible polymer layer 30 may be formed into a colorless polyimide (CPI) organic film layer from CPI. At the same time, it is also possible that colorless polyamic acid (CPAA) is modified employing inorganic rigid powder nano SiO₂, and then a modified CPI organic film is obtained, which may improve the hardness of the flexible polymer layer 30 while ensuring the flexibility of the flexible polymer layer 30. Above the first thermoplastic material layer 20 is the flexible polymer layer 30, and below is the substrate 10, thereby making the display cover plate have excellent hardness, folding performance, impact resistance performance and relatively good resilience, and improving the reliability of the display cover plate.

The thickness of the flexible polymer layer 30 may be 30 μm to 150 μm, for example, 30 μm, 50 μm, 70 μm, 90 μm, 100 μm, 130 μm, 150 μm, etc., which are not listed here in the present disclosure. Preferably, the thickness of the flexible polymer layer 30 is 50 μm to 100 μm. Alternatively, the thickness of the flexible polymer layer 30 may be less than 30 μm or greater than 150 μm as well, which is not limited in the present disclosure. Preferably, the widths and the lengths of the flexible polymer layer 30 and the first thermoplastic material layer 20 are the same. In other words, the orthographic projections of the flexible polymer layer 30 and the first thermoplastic material layer 20 on the substrate 10 completely coincide with each other, and the flexible polymer layer 30 forms a full coverage for the surface of one side of the first thermoplastic material layer 20, thereby further improving the folding performance, the impact resistance performance and the resilience performance of the display cover plate.

Exemplarily, the hardened layer (HC) 40 may be formed on one side of the flexible polymer layer 30 away from the first thermoplastic material layer 20 through coating process, and the base material forming the hardened layer 40 is at least one of polyester resin (PET), polymethyl methacrylate (PMMA), triacetate cellulose (TAC), polycycloolefin (COP) and polyimide (PI).

The thickness of the hardened layer 40 may be 2 μm to 20 μm for example, 2 μm, 5 μm, 10 μm, 13 μm, 17 μm, 20 μm, etc., which are not listed here in the present disclosure. Preferably, the thickness of the hardened layer 40 is 5 μm to 10 μm. Alternatively, the thickness of the hardened layer 40 may be less than 2 μm or greater than 20 μm as well, which is not limited in the present disclosure. Preferably, the widths and lengths of the hardened layer 40 and the flexible polymer layer 30 are the same. In other words, the orthographic projections of the hardened layer 40 and the flexible polymer layer 30 on the substrate 10 completely coincide with each other, and the hardened layer 40 forms a full coverage for the surface of one side of the flexible polymer layer 30, thereby further improving the folding performance, the impact resistance performance and the resilience performance of the display cover plate.

As shown in FIG. 2, the display cover plate further includes: a second thermoplastic material layer 50. The second thermoplastic material layer 50 is provided on one side of the substrate 10 away from the first thermoplastic material layer 20. Through cooperation of the second thermoplastic material layer 50 with the first thermoplastic material layer 20, the coverage for both an upper side and a lower side of the substrate 10 is formed, and the microcracks on the surfaces of the substrate can be covered, thereby further improving the impact resistance performance, the resilience performance and the hardness of the display cover plate.

Exemplarily, material of the second thermoplastic material layer 50 includes at least one of polyethylene (PE), polypropylene (PP), polyvinyl chloride (PVC), polystyrene (PS), polyoxymethylene (POM), polycarbonate (PC), polyamide (PA), cellulose-acrylic ester molded plastic (CAEMP), thermoplastic polyimide (TPI), thermoplastic polyurethane (TPU) and thermoplastic vulcanizate (TPV). Preferably, the second thermoplastic material layer 50 is made of thermoplastic polyimide (TPI) or thermoplastic polyurethane (TPU) material.

The thickness of the second thermoplastic material layer 50 may be 30 μm to 150 μm, for example, 30 μm, 50 μm, 70 μm, 90 μm, 100 μm, 130 μm, 150 μm, etc., which are not listed here in the present disclosure. Preferably, the thickness of the second thermoplastic material layer 50 is 50 μm to 100 μm. The width and the length of the second thermoplastic material layer 50 may be designed according to actual needs. The thickness of the second thermoplastic material layer 50 may be less than 30 μm or greater than 150 μm as well, and the widths, the lengths and the thicknesses of the second thermoplastic material layer 50 and the substrate 10 may be the same or different, which is not limited in the present disclosure. Preferably, the widths and lengths of the second thermoplastic material layer 50 and the substrate 10 are the same. In other words, the orthographic projections of the second thermoplastic material layer 50 and the substrate 10 on the preset reference plane completely coincide with each other, and the second thermoplastic material layer 50 forms a full coverage for the surface of the other side of the substrate 10, thereby completely covering the microcracks on the surface of the substrate 10, and further improving the impact resistance performance and hardness of the display cover plate. In addition, the material, thicknesses, lengths and widths of the second thermoplastic material layer 50 and the first thermoplastic material layer 20 may be the same or different, respectively, which is not limited in the present disclosure.

Below are method embodiments of the present disclosure, and may be used for manufacturing device embodiments of the present disclosure. For details not disclosed in the method embodiments of the present disclosure, the device embodiments of the present disclosure are referred to.

The present disclosure further provides a method for manufacturing a display cover plate including the following steps as shown in FIG. 3.

In step S100, a flexible polymer layer is provided.

In step S200, a first thermoplastic material layer is formed on one side of the flexible polymer layer.

In step S300, a hardened layer is formed on one side of the flexible polymer layer away from the first thermoplastic material layer.

In step S400, a substrate is formed on one side of the first thermoplastic material layer away from the flexible polymer layer.

In the method for manufacturing the display plate cover provided by the present disclosure, the flexible polymer layer is combined with the substrate through the first thermoplastic material layer, thereby avoiding the structure of OCA attaching, and effectively improving the pencil hardness and the impact resistance performance of the display cover plate.

Hereinafter, steps of the method for manufacturing the display cover plate in this exemplary embodiment will be further explained.

In step S100, the flexible polymer layer is provided.

Specifically, as shown in FIG. 1, the flexible polymer layer 30 is provided, the flexible polymer layer 30 may be formed into a CPI organic film layer from CPI. At the same time, it is also possible that CPAA is modified employing inorganic rigid powder nano SiO₂, and then a modified CPI organic film is obtained, which may improve the hardness of the flexible polymer layer 30 while ensuring the flexibility of the flexible polymer layer 30. The thickness of the flexible polymer layer 30 may be 30 μm to 150 μm for example, 30 μm, 50 μm, 70 μm, 90 μm, 100 μm, 130 μm, 150 μm, etc., which are not listed here in the present disclosure. Preferably, the thickness of the flexible polymer layer 30 is 50 μm to 100 μm. Alternatively, the thickness of the flexible polymer layer 30 may be less than 30 μm or greater than 150 μm as well, which is not limited in the present disclosure.

In step S200, the first thermoplastic material layer is formed on one side of the flexible polymer layer.

Specifically, as shown in FIG. 1, the first thermoplastic material layer 20 may be formed on one side of the flexible polymer layer 30 through manners such as hot pressing and the like. Material of the first thermoplastic material layer 20 includes at least one of polyethylene (PE), polypropylene (PP), polyvinyl chloride (PVC), polystyrene (PS), polyoxymethylene (POM), polycarbonate (PC), polyamide (PA), cellulose-acrylic ester molded plastic (CAEMP), thermoplastic polyimide (TPI), thermoplastic polyurethane (TPU) and thermoplastic vulcanizate (TPV). Preferably, the first thermoplastic material layer 20 is made of thermoplastic polyimide (TPI) or thermoplastic polyurethane (TPU) material.

The thickness of the first thermoplastic material layer 20 may be 30 μm to 150 μm, for example, 30 μm, 50 μm, 70 μm, 90 μm, 100 μm, 130 μm, 150 μm, etc., which are not listed here in the present disclosure. Preferably, the thickness of the first thermoplastic material layer 20 is 50 μm to 100 μm. The width and the length of the first thermoplastic material layer 20 may be designed according to actual needs, and the thickness of the first thermoplastic material layer 20 may be less than 30 μm or greater than 150 μm as well.

In step S300, the hardened layer is formed on one side of the flexible polymer layer away from the first thermoplastic material layer.

Specifically, as shown in FIG. 1, the hardened layer 40 may be formed on one side of the flexible polymer layer 30 away from the first thermoplastic material layer 20 through processes such as coating and the like, and the base material forming the hardened layer 40 is at least one of polyester resin (PET), polymethyl methacrylate (PMMA), triacetate cellulose (TAC), polycycloolefin (COP) and polyimide (PI).

The thickness of the hardened layer 40 may be 2 μm to 20 μm, for example, 2 μm, 5 μm, 10 μm, 13 μm, 17 μm, 20 μm, etc., which are not listed here in the present disclosure. Preferably, the thickness of the hardened layer 40 is 5 μm to 10 μm. Alternatively, the thickness of the hardened layer 40 may be less than 2 μm or greater than 20 μm as well, which is not limited in the present disclosure.

In step S400, the substrate is formed on one side of the first thermoplastic material layer away from the flexible polymer layer.

Specifically, as shown in FIG. 1, the substrate 10 is combined on one side of the first thermoplastic material layer 20 away from the flexible polymer layer 30 through manners such as hot pressing and the like, and the substrate 10 may be formed from UTG. The thickness of UTG may be 30 μm to 150 μm, for example, 30 μm, 50 μm, 70 μm, 90 μm, 100 μm, 130 μm, 150 μm, etc., which are not listed here in the present disclosure. Preferably, the thickness of UTG is 50 μm to 100 μm. The width and the length of UTG may be designed according to actual needs, and the thickness of UTG may be less than 30 μm or greater than 150 μm as well, which is not limited in the present disclosure.

The substrate may be formed from inorganic material, for example, an inorganic glass substrate. The conventional display cover plate may permanently deform under a high temperature and high humidity condition, thereby preventing itself from restoring to a flat state. In comparison, the substrate 10 according to the present disclosure employs inorganic material, and has relatively good restorability, and the display cover plate may be restored to a relatively flat state even under a high temperature and high humidity condition, thereby improving the foldability, the durability and the reliability of the display cover plate.

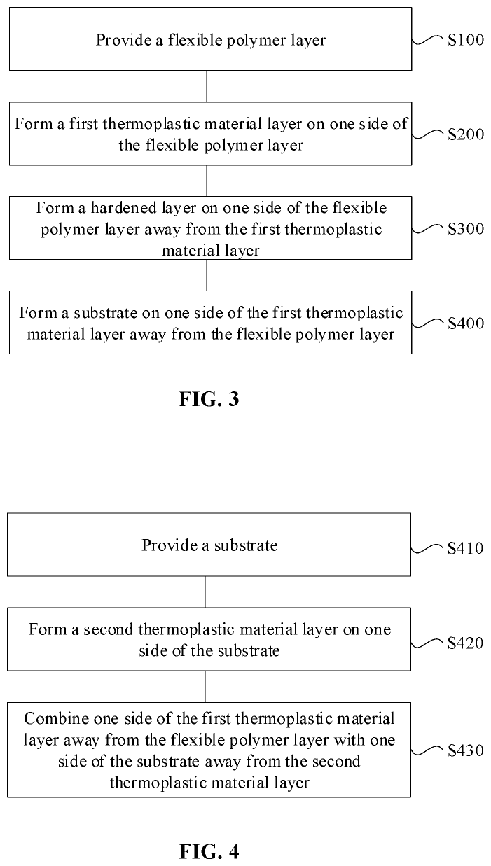

Exemplarily, in step S400, forming the substrate on one side of the first thermoplastic material layer away from the flexible polymer layer includes the following steps S410 to S430, as shown in FIG. 4.

In step S410, a substrate is provided.

Specifically, as shown in FIG. 2, the substrate 10 is provided and may be formed from UTG.

In step S420, a second thermoplastic material layer is formed on one side of the substrate.

Specifically, as shown in FIG. 2, the second thermoplastic material layer 50 is formed on one side of the substrate 10 through manners such as hot pressing and the like. Material of the second thermoplastic material layer 50 includes at least one of polyethylene (PE), polypropylene (PP), polyvinyl chloride (PVC), polystyrene (PS), polyoxymethylene (POM), polycarbonate (PC), polyamide (PA), cellulose-acrylic ester molded plastic (CAEMP), thermoplastic polyimide (TPI), thermoplastic polyurethane (TPU) and thermoplastic vulcanizate (TPV). Preferably, the second thermoplastic material layer 50 is made of thermoplastic polyimide (TPI) or thermoplastic polyurethane (TPU) material.

The thickness of the second thermoplastic material layer 50 may be 30 μm to 150 μm, for example, 30 μm, 50 μm, 70 μm, 90 μm, 100 μm, 130 μm, 150 μm, etc., which are not listed here in the present disclosure. Preferably, the thickness of the second thermoplastic material layer 50 is 50 μm to 100 μm. The width and the length of the second thermoplastic material layer 50 may be designed according to actual needs, the thickness of the second thermoplastic material layer 50 may be less than 30 μm or greater than 150 μm as well, and the widths, the lengths and the thicknesses of the second thermoplastic material layer 50 and the substrate may be the same or different, which is not limited in the present disclosure.

In step S430, one side of the first thermoplastic material layer away from the flexible polymer layer is combined with one side of the substrate away from the second thermoplastic material layer.

Specifically, as shown in FIG. 2, one side of the substrate 10 away from the second thermoplastic material layer 50 is combined with one side of the first thermoplastic material layer 20 away from the flexible polymer layer 30 through manners such as hot pressing or the like. The second thermoplastic material layer 50 and the first thermoplastic material layer 20 form a coverage for the surfaces on both sides of the substrate 10, thereby completely covering the microcracks on the surfaces of the substrate 10, and further improving the impact resistance performance and the hardness of the display cover plate.

The present disclosure further provides a display panel including the foregoing display cover plate, and for the beneficial effect of the display panel, the foregoing discussion on the display cover plate is referred to, which is not elaborated here.

The present disclosure further provides a display device including the foregoing display panel. The display panel is a display device including a display function, for example, a mobile phone, a tablet, a notebook computer, a TV set, an advertisement display device and the like, which are not listed here. For the beneficial effect of the display panel, the discussion on the display cover plate is referred to, which is not elaborated here.

In addition, although steps of the methods in the present disclosure are described in the drawings in a particular order, this does not require or imply that these steps must be performed in this particular order or that the desired result can be achieved only if all the steps shown are performed. Additionally or alternatively, certain steps may be omitted, multiple steps may be combined into one step so as to be performed, and/or one step may be decomposed into multiple steps so as to be performed, etc.

Other implementation solutions of the present disclosure will be readily contemplated by those skilled in the art upon consideration of the specification and practice of the invention disclosed here. This application is intended to cover any variations, uses, or adaptations of the present disclosure that follow the general principles of the present disclosure and include common knowledge or conventional technical means in the art not disclosed by the present disclosure. The specification and embodiments are regarded as exemplary only, and the true scope and spirit of the present disclosure are indicated by the appended claims.

1. A display cover plate, comprising:
a substrate;
a first thermoplastic material layer provided on one side of the substrate;
a flexible polymer layer provided on one side of the first thermoplastic material layer away from the substrate; and
a hardened layer provided on one side of the flexible polymer layer away from the first thermoplastic material layer.

2. The display cover plate according to claim 1, wherein the display cover plate further comprises:
a second thermoplastic material layer provided on one side of the substrate away from the first thermoplastic material layer.

3. The display cover plate according to claim 1, wherein material of the first thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

4. The display cover plate according to claim 2, wherein material of the second thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

5. The display cover plate according claim 1, wherein a thickness of the first thermoplastic material layer is 30 μm to 150 μm.

6. The display cover plate according to claim 2, wherein a thickness of the second thermoplastic material layer is 30 μm to 150 μm.

7. The display cover plate according to claim 1, wherein the substrate is inorganic material.

8. A method for manufacturing a display cover plate, comprising:
providing a flexible polymer layer;
forming a first thermoplastic material layer on one side of the flexible polymer layer;
forming a hardened layer on another side of the flexible polymer layer away from the first thermoplastic material layer; and
forming a substrate on one side of the first thermoplastic material layer away from the flexible polymer layer.

9. The method according claim 8, further comprising:
forming a second thermoplastic material layer on one side of the substrate; and
combining the one side of the first thermoplastic material layer away from the flexible polymer layer with one side of the substrate away from the second thermoplastic material layer.

10. A display panel, comprising a display cover plate, wherein the display cover plate comprises:
a substrate;
a first thermoplastic material layer provided on one side of the substrate;
a flexible polymer layer provided on one side of the first thermoplastic material layer away from the substrate; and
a hardened layer provided on one side of the flexible polymer layer away from the first thermoplastic material layer.

11. A display device, comprising the display panel according to claim 10.

12. The display panel according to claim 10, wherein the display cover plate further comprises:
a second thermoplastic material layer provided on one side of the substrate away from the first thermoplastic material layer.

13. The display panel according to claim 10, wherein material of the first thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

14. The display panel according to claim 12, wherein material of the second thermoplastic material layer comprises at least one of polyethylene, polypropylene, polyvinyl chloride, polystyrene, polyoxymethylene, polycarbonate, polyamide, acrylic plastic, thermoplastic polyimide, thermoplastic polyurethane and thermoplastic vulcanizate.

15. The display panel according claim 10, wherein a thickness of the first thermoplastic material layer is 30 μm to 150 μm.

16. The display panel according to claim 12, wherein a thickness of the second thermoplastic material layer is 30 μm to 150 μm.

17. The display panel according to claim 10, wherein the substrate is inorganic material.
